(19) United States
(12) Patent Application Publication
(10) Pub. No.: US 2015/0199928 A1
(43) Pub. Date: Jul. 16, 2015

(54) Light-Emitting Diode Sign

(71) Applicant: Ralph A. Ector, JR., Athens, TN (US)

(72) Inventor: Ralph A. Ector, JR., Athens, TN (US)

(21) Appl. No.: 14/595,292

(22) Filed: Jan. 13, 2015

Related U.S. Application Data
(60) Provisional application No. 61/928,143, filed on Jan. 16, 2014.

(51) Int. Cl. G09F 13/22; G09F 13/10; F21K 99/00; G09F 13/04

(52) U.S. Cl. CPC G09F 13/22; G09F 13/0413; G09F 13/10; F21K 9/90; G09F 2013/222

(57) ABSTRACT

An illuminated sign display formed of a transparent acrylic board and a graphic viewable on a front surface of the acrylic board. The graphic is illuminated by a light ribbon that includes a number of light-emitting diode (LED) lights. The light ribbon positioned into a channel formed into the back surface of the acrylic board. The board may include more than one channel, where lights may be positioned. A coating may be applied to the exterior of portions of the sign, which may, among other things, be used to create the graphic. Alternatively, graphics may also be applied to an outer acrylic plate that is mounted to the front surface of the acrylic board or mounted to an intermediate plate that is mounted between the outer acrylic plate and the acrylic board.

### CROSS-REFERENCE To RELATED APPLICATION

This application claims priority to U.S. Provisional Application Ser. No. 61/928,143, filed Jan. 16, 2014, and entitled LIGHT-EMITTING DIODE SIGN, incorporated by reference herein in its entirety.

### FIELD

This invention relates to the field of light-emitting diode (LED) signs. More particularly, this invention relates to an LED sign having a transparent resin board having coated portions that prevent the transmission of light and uncoated portions that permit the transmission of light. The board includes a channel and an LED ribbon is placed into the channel to illuminate portions of the sign.

### SUMMARY

The present disclosure provides various embodiments of an illuminated sign display. In certain embodiments, the display includes a transparent acrylic board having a perimeter edge, a front surface, and a back surface; a graphic viewable on the front surface of the acrylic board; a first channel formed into the back surface of the acrylic board near the perimeter edge, wherein the channel has an interior wall and an exterior wall; and a light ribbon that includes a number of light-emitting diode (LED) lights that are configured to illuminate the acrylic board and graphic.

The sign may include a power source for powering the LED lights, such as a wall plug or one or more batteries, and a controller for controlling the function of the LED lights. Each of the plurality of LED lights may include at least a red diode, a yellow diode and a blue diode. The light ribbon is positioned within the channel and is oriented such that light is directed through the interior wall. A seal may be provided for securing the light ribbon in the channel. For example, the seal may be vinyl tubing.

The illuminated sign display may also include an outer acrylic plate that is configured to mount to the front surface of the acrylic board. Also, an intermediate acrylic plate may be placed between the acrylic board and the outer acrylic plate. The intermediate acrylic plate may include an opening formed in its central portion. A portion of an external surface of the acrylic board, outer acrylic plate or intermediate acrylic plate may be frosted in order to diffuse the light from the LED lights.

The channel may be formed along the entire perimeter edge of the board or along just a portion of the perimeter edge. Sometimes, a second channel spaced apart from the first channel may be formed into the back surface of the acrylic board as well.

The illuminated sign display may include one or more coatings applied to at least a portion of an external surface of the acrylic board to form a coated portion. The coated portion prevents light from the LED lights from being transmitted through the coated portion of the board. Also, sometimes, the graphic is formed by the one or more coatings applied to the front surface of the acrylic board. Alternatively, the graphic may be affixed to an outward facing surface of the outer acrylic plate.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a front view of an illuminated sign display according to a first embodiment of the present invention;

FIG. 2 is a back view of the illuminated sign display depicted in FIG. 1;

FIG. 3 is a back view of the illuminated sign display depicted in FIG. 1 showing a light ribbon disposed in a perimeter channel;

FIG. 4 is a sectional view of the illuminated sign display in FIG. 3 taken along line B-B;

FIG. 5 is a perspective view of an illuminated sign display according to a second embodiment of the present invention;

FIG. 6 is an exploded view of the illuminated sign display shown in FIG. 5;

FIG. 7 is a back view of the illuminated sign display depicted in FIG. 5;

FIG. 8 is a side view of the illuminated sign display depicted in FIG. 5;

FIG. 9 is a sectional view of the illuminated sign display in FIG. 7 taken along line A-A;

FIG. 10 is a back view of the illuminated sign display depicted in FIG. 5 after a portion of the back has been painted;

### DETAILED DESCRIPTION

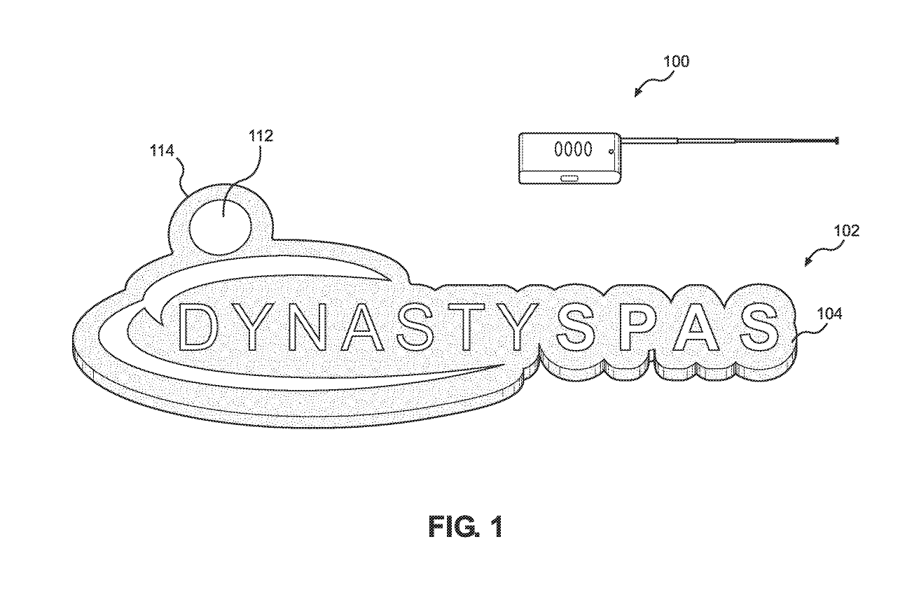

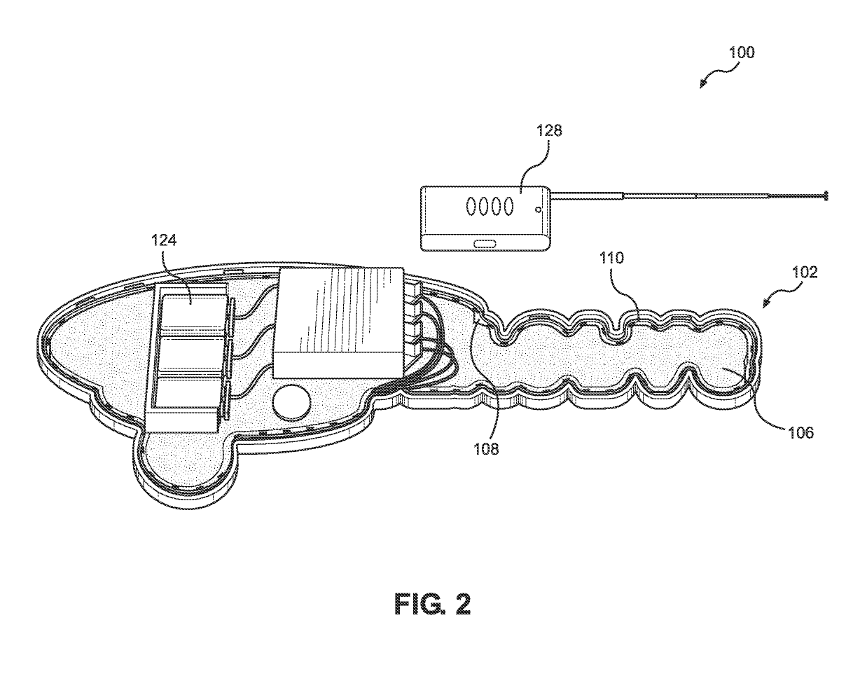

Turning now to the figures and, in particular, to FIGS. 1 and 2, there is provided an illuminated sign 100 according to an embodiment of the present invention. The sign 100 is preferably made of a transparent acrylic board 102. The board 102 has a front surface 104 and a back surface 106 and is preferably about ½″ thick. For example, a ½″ thick clear acrylic board by Chemcast® would be suitable for this application.

The board 102 may be cut into any shape, and a channel 108 is cut into the back surface 106 along a perimeter edge of the board. The channel 108 extends partially into the board 102 but does not extend all the way through the board. The channel 108 may be cut along the entire perimeter or along one or more portions of the board.

A ribbon 110 of lights, such as LED lights, is mounted to the board 102 within the channel 108 and oriented such that the light is directed towards the center of the board. An example of a suitable RGB LED ribbon includes LED 5 METER (16.5FT) REEL RGB 300 LEDs NON-WATERPROOF SERIES 72 WATT 12V DC or, if plain white is used, LED 5m reel WHITE 300 LEDs Pure White 7000K Non-Waterproof Series.

One or more coatings may be applied to any of the surfaces of the board 102, including the front surface 104 and back surface 106. One primary purpose of these coatings is to cause light to be reflected into the board 102 in order to improve the overall brightness of the sign 100. The coatings may include at least one reflective coating, such as white paint. A suitable paint for this application is Spraylat® brand B70-400 Star-Brite

White 11. Additional coatings may then be applied to the board 102. For example, the board 102 may then be painted with a dark paint in order to prevent the transmission of light. Suitable dark paints include Matthews brand satin black paint.

In certain locations, such as on the front surface 104, one or more of the coatings are removed or are never applied. The reason for removing coatings or not applying coatings is to allow light to pass through these areas of the sign 100. The uncoated portions may be frosted, such as by sandblasting, so that the openings will appear brightly lit by the light transmitted into the board by the lights. However, certain combinations of paints may eliminate the need for etching.

Accordingly, using the methods described above, the sign 100 may include transmitting areas 112, where light is permitted to pass, as well as non-transmitting areas 114, where light is not permitted to pass. The combination of transmitting areas 112 and non-transmitting areas 114 may be used to create desired sign features, such as letters, characters, shapes, logos, etc.

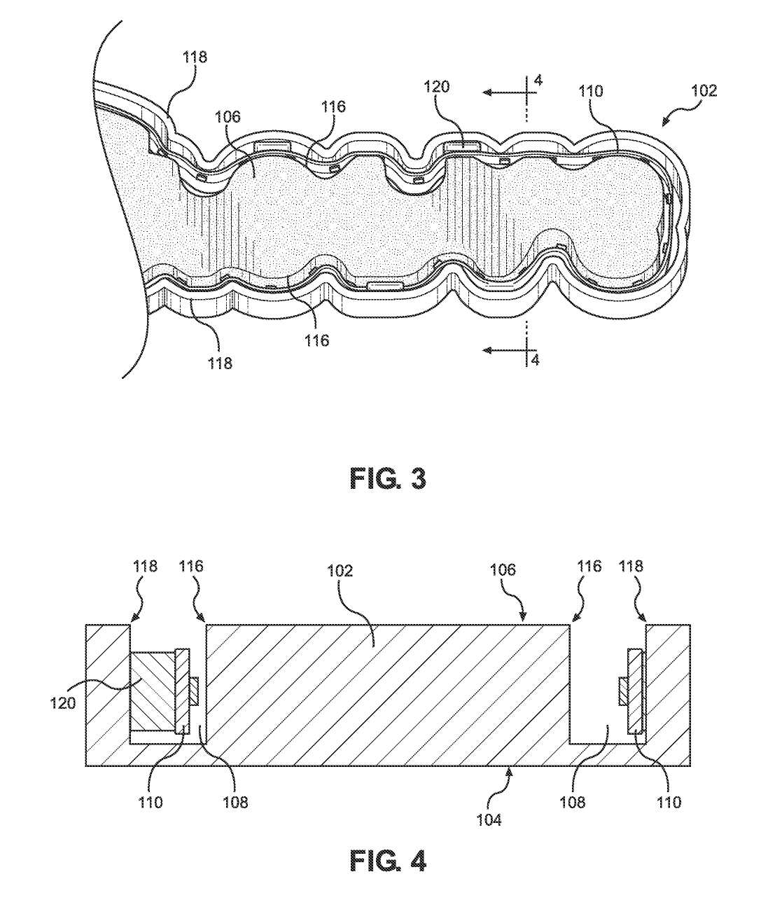

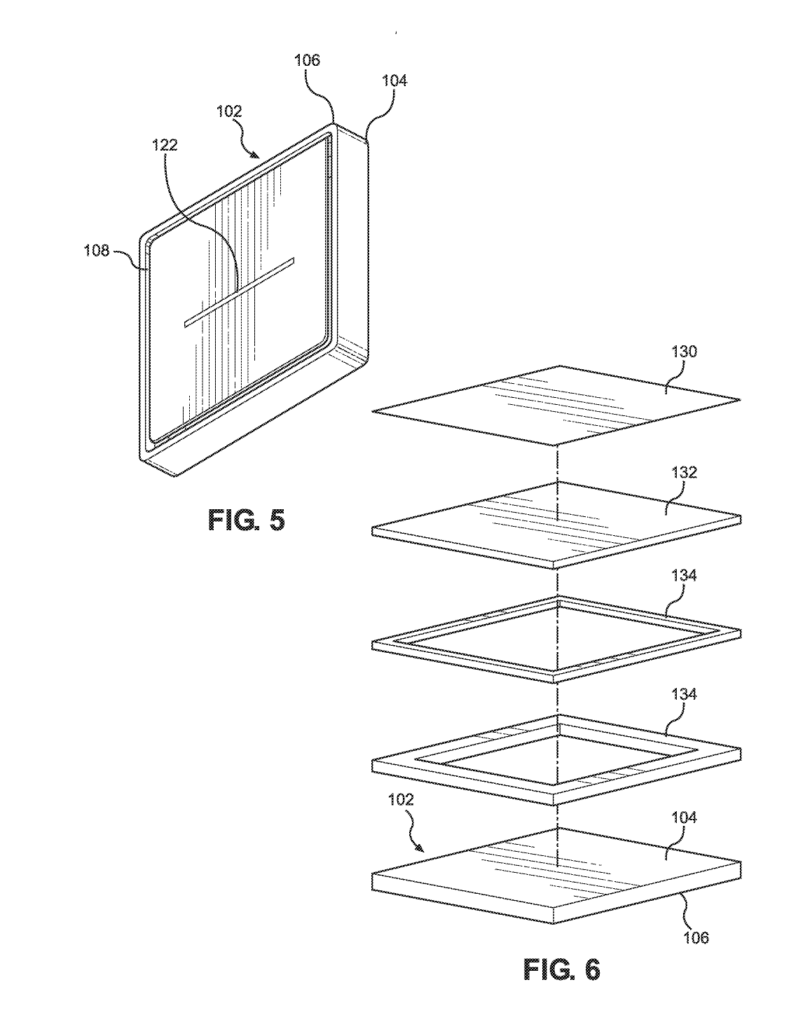

With reference to FIGS. 3 and 4, the back surface 106 of the sign 100 includes a channel 108 that is formed near the perimeter edge of the board 102. The channel 108 is preferably cut with a computer-controlled router, but it could be formed by other processes, such as molding. Once formed, the channel 108 preferably includes an interior wall 116 that is closer to the center of the board 102 and an exterior wall 118 that is closer to the perimeter edge of the board.

The light ribbon 110 is then inserted into the channel 108 between the interior and exterior walls 116, 118. Sometimes it is preferable to have the ribbon 110 disposed immediately adjacent one wall or the other. For example, it may sometimes be desirable to position the light ribbon 110 close to the interior wall 116 in order to increase the amount of light transmitted into the board to increase brightness. At other times, it may be desirable to push the light ribbon 110 away from the interior wall 116 and towards the exterior wall 118 to avoid creating bright spots in the sign 100. In particular, when the light ribbon 110 is positioned near the exterior wall 118, the light shines across the channel 108 and more evenly lights the interior wall 116. In this position, it would be more difficult to observe individual lights from the front side of the sign. On the other hand, if the light ribbon 110 is positioned near the interior wall 116, at certain angles, it may be possible to observe bright spots along the edges of the letters or graphics caused by the close proximity of the light.

The ribbon 110 may be held in the desired position using positioning member 120, which may include clips, blocks, foam, epoxies, and the like. For example, a suitable type of foam includes Ultraboard brand of 3/16″ thick translucent white foam board.

The lights in the light ribbon 110 may be white or may be multi-colored. For example, in certain embodiments the light ribbon may include a number of light diode sections, where each includes red, yellow and blue diodes. By turning on various combinations of the diodes, any color may be produced. For example, if all three diodes are on, a white light will be produced.

In this embodiment of there is one channel 108 around the perimeter of the sign 100 that illuminates all of the characters and graphics within the sign. However, in a larger sign, the light ribbon 110 placed in the perimeter channel 108 may be located too far away from certain portions of the sign, such as at the middle of the sign, to sufficiently illuminate them. Accordingly, in certain embodiments, one or more interior channels 122 may be provided in addition to the perimeter channel 108 discussed above. A light ribbon 110 placed into the interior channel 122 would enable all areas of the sign to be illuminated. Sometimes, it may be desirable for one or more interior channels 122 to be used in place of the perimeter channel 10.

As shown in FIG. 2, in this embodiment, power is provided by light ribbon 110 using batteries 124. In other embodiments, the sign may be powered by an exterior power source, such as a wall plug. A battery compartment may be mounted upon the back surface 106 of the sign 100 in order to secure and conceal the batteries 124.

The sign 100 may also include a controller 126 for controlling the illumination of the lights of the light ribbon 110. In this case, a remote control unit 128 is also provided in order to provide commands to the controller 126 remotely. The remote control 128 may be used to turn the lights of the light ribbon 110 on and off, to change the color of the lights, and to choose between various lighting effects.

With reference now to FIG. 6, in certain embodiments, a number of layers of clear acrylic may be stacked together and affixed to the front surface 104 of the board 102. These layers provide an alternative surface for affixing a desired sign feature to the sign. Recall that, in an earlier embodiment, sign features were created using various coatings applied directly to the front surface 104 of the board 102. In this embodiment, however, sign features, in the form of a graphics layer 130, are applied to an outer acrylic plate 132, which is then mounted either directly or indirectly to the front surface 104 of the board 102.

As in earlier embodiments, the graphics layer 130 may include one or more coatings. However, the graphics layer may also include layers that are mounted to the outer acrylic plate 132. For example, graphics, photos, etc. may be printed onto a sheet that is then adhered to the outer acrylic plate 132. Next, one or more intermediate plates 134 may be placed between the outer plate 132 and the board 102. The various components of the sign 100, including the board 102, plates 132, 134, light ribbon, etc. may be secured together using glue, tape and other similar securing means. A side view of the sign 100 after the board 102 and plates 132, 134 have been secured together is provided in FIG. 8.

The intermediate plates 132 shown in FIG. 6 include only a perimeter edge and have an open middle section. The exterior surfaces of the board 102, outer plate 132, and the one or more intermediate plates 134 may frosted in order to diffuse the light that is being transmitted. This assists in preventing individual light sources from discerned and in providing a more evenly lit sign. The frosting process may be accomplished, for example, by sandblasting.

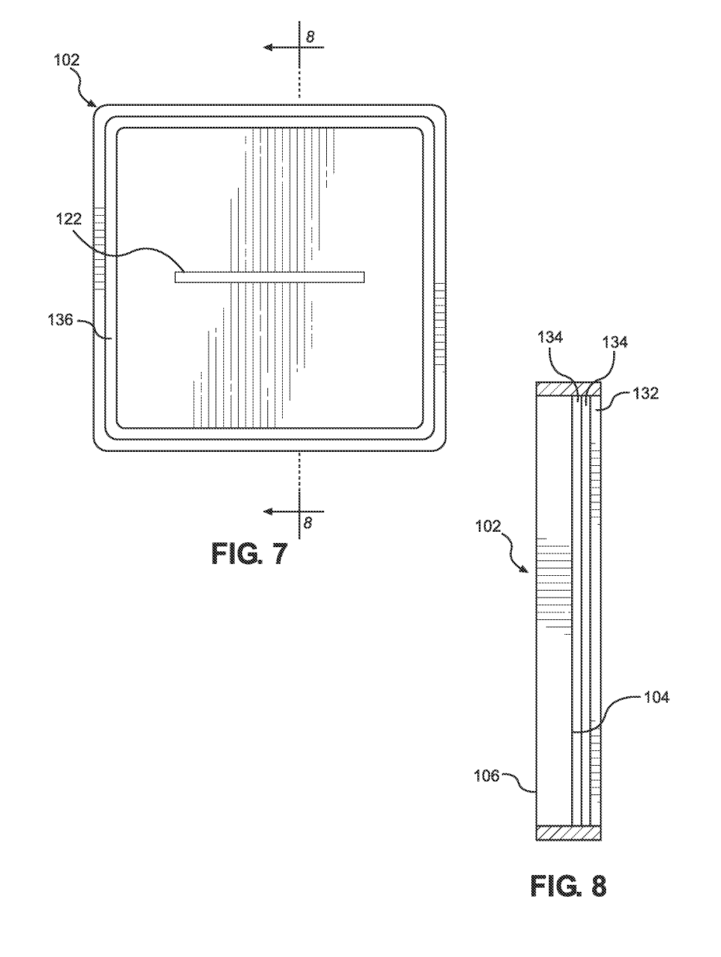

As shown in FIG. 7, even when intermediate plates 134 and an outer plate 132 are affixed to the front surface 104 of the sign 100, the back surface 106 remains unchanged. In particular, the perimeter channel 108 and interior channel 122 remain accessible and one or more light ribbons are inserted into the channels in order to illuminate the sign 100.

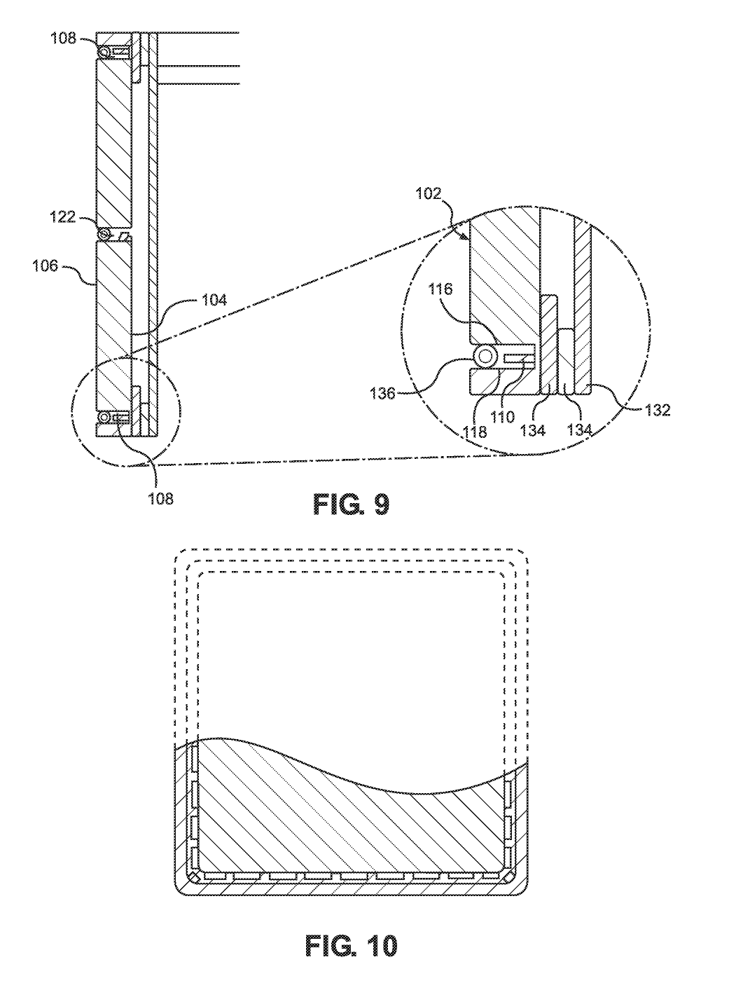

With reference to FIG. 7 and FIG. 9, after the light ribbons are secured to the sign, a seal 136 may be placed over each of the channels. In this particular embodiment, the seal 136 consists of vinyl tubing, which has been inserted into the channel 108.

With reference to FIG. 10, as a final step, a coating may be applied the back surface 106 of the board 102 and other exterior surfaces, such as the sides of the sign. In addition to sealing the sign, the coating may also be used to reflect light in order to improve the brightness of the sign.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An illuminated sign display comprising:
a transparent acrylic board having a perimeter edge, a front surface, and a back surface;
a graphic viewable on the front surface of the acrylic board;
a first channel formed into the back surface of the acrylic board proximate the perimeter edge, the channel having an interior wall and an exterior wall; and
a light ribbon comprising a plurality of light-emitting diode (LED) lights configured to illuminate the acrylic board and graphic, the light ribbon disposed within the channel and oriented such that light is directed through the interior wall.

2. The illuminated sign display of claim 1 further comprising an outer acrylic plate configured to mount to the front surface of the acrylic board, wherein the graphic is affixed to an outward facing surface of the outer acrylic plate.

3. The illuminated sign display of claim 2 further comprising an intermediate acrylic plate disposed between the acrylic board and the outer acrylic plate.

4. The illuminated sign display of claim 3 wherein the intermediate acrylic plate has a central portion and wherein an opening is formed in the central portion.

5. The illuminated sign display of claim 1 wherein each of the plurality of LED lights comprises at least a red diode, a yellow diode and a blue diode.

6. The illuminated sign display of claim 1 further comprising a power source for powering the LED lights.

7. The illuminated sign display of claim 1 further comprising a controller for controlling the function of the LED lights.

8. The illuminated sign display of claim 7 wherein the power source is selected from the group consisting of a wall plug and one or more batteries.

9. The illuminated sign display of claim 1 wherein the channel is disposed along the entire perimeter edge of the board.

10. The illuminated sign display of claim 1 further comprising a second channel spaced apart from the first channel and formed into the back surface of the acrylic board.

11. The illuminated sign display of claim 1 further comprising a seal for securing the light ribbon in the channel.

12. The illuminated sign display of claim 11 wherein the seal is vinyl tubing.

13. The illuminated sign display of claim 1 further comprising one or more coatings applied to at least a portion of an external surface of the acrylic board to form a coated portion, wherein the coated portion prevents light from the LED lights from being transmitted through the coated portion of the board.

14. The illuminated sign display of claim 13 wherein the graphic is formed by the one or more coatings applied to the front surface of the acrylic board.

15. The illuminated sign display of claim 1 wherein at least a portion of an external surface of the acrylic board is frosted.

16. A method for producing an illuminated sign display, the method comprising the steps of:
providing a transparent acrylic board having a perimeter edge, a front surface, and a back surface;
providing a graphic viewable on the front surface of the acrylic board;
providing a first channel having an interior wall and an exterior wall into the back surface of the acrylic board proximate the perimeter edge;
positioning a light ribbon comprising a plurality of light-emitting diode (LED) lights configured to illuminate the acrylic board and graphic within the channel; and
orienting the light ribbon such that light from the LED lights is directed through the interior wall.

17. The method for producing an illuminated sign display of claim 16 further comprising the step of providing a second channel spaced apart from the first channel and formed into the back surface of the acrylic board.

18. The method for producing an illuminated sign display of claim 16 further comprising the step of providing an outer acrylic plate configured to mount to the front surface of the acrylic board, wherein the graphic is affixed to an outward facing surface of the outer acrylic plate.

19. The method for producing an illuminated sign display of claim 18 further comprising the step of providing an intermediate acrylic plate disposed between the acrylic board and the outer acrylic plate.

20. The method for producing an illuminated sign display of claim 16 further comprising the step providing one or more coatings applied to at least a portion of an external surface of the acrylic board to form a coated portion, wherein the coated portion prevents light from the LED lights from being transmitted through the coated portion of the board.
